(19) United States
(12) Patent Application Publication
(10) Pub. No.: US 2016/0152882 A1
(43) Pub. Date: Jun. 2, 2016

(54) CATALYTIC SYSTEM FOR BREAKER FLUID FORMULATIONS

(71) Applicant: M-I L.L.C., Houston, TX (US)

(72) Inventors: Kjetil Eriksen, Katy, TX (US); Clotaire-Marie Eyaa Allogo, Sugar Land, TX (US)

(21) Appl. No.: 14/957,135

(22) Filed: Dec. 2, 2015

Related U.S. Application Data
(60) Provisional application No. 62/086,602, filed on Dec. 2, 2014.

(51) Int. Cl. C09K 8/06; C02F 1/72

(52) U.S. Cl. CPC C09K 8/06; C02F 1/725; C02F 2103/36

(57) ABSTRACT

Methods may include circulating a breaker fluid into a wellbore, the breaker fluid containing: a base fluid, a peroxide source, and a catalyst. In another aspect, methods may include drilling a wellbore with a drilling fluid containing a catalyst, and circulating a breaker fluid into a wellbore, the breaker fluid containing a base fluid, and a peroxide source. In yet another aspect, methods may include treating a contaminated fluid with a treatment fluid containing a base fluid, a peroxide source, and a catalyst.

This application claims the benefit of U.S. Provisional Application No. 62/086602 filed on Dec. 2, 2014 incorporated by reference herein in its entirety.

### BACKGROUND

During the drilling of a wellbore, various fluids are typically used in the well for a variety of functions. The fluids may be circulated through a drill pipe and drill bit into the wellbore, and then may subsequently flow upward through wellbore to the surface. During this circulation, the drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the subterranean formation by providing sufficient hydrostatic pressure to prevent the ingress of formation fluids into the wellbore, to cool and lubricate the drill string and bit, and/or to maximize penetration rate.

Upon completion of drilling, a filter cake may develop on the surfaces of a wellbore from the accumulation of additives from a drilling fluid. This filter cake may stabilize the wellbore during subsequent completion operations such as placement of a gravel pack in the wellbore. Additionally, during completion operations, when fluid loss is suspected, a fluid loss pill of polymers and/or bridging agents may be spotted into the wellbore to reduce or prevent such fluid loss by injection of other completion fluids behind the fluid loss pill to a position within the wellbore which is immediately above a portion of the formation where fluid loss is suspected. Injection of fluids into the wellbore is then stopped, and fluid loss will then move the pill toward the fluid loss location.

After any completion operations have been accomplished, removal of filter cake (formed during drilling and/or completion) remaining on the sidewalls of the wellbore may be necessary. Although filter cake formation and use of fluid loss pills are often used in drilling and completion operations, these barriers can present an impediment to the production of hydrocarbon or other fluids from the well, or to the injection of water and/or gas, if, for example, the rock formation is still plugged by the barrier. Because filter cake is compact, it often adheres strongly to the formation and may not be readily or completely flushed out of the formation by fluid action alone.

### DETAILED DESCRIPTION

Embodiments disclosed herein are directed to catalytic systems that may be used to control the generation and concentration of oxidants depending on the requirements of a given application. In one or more embodiments, catalyst systems in accordance with the present disclosure may contain a peroxide source and a catalyst that controls the initiation of free radical production and/or control over the rate of free radical production. Once generated, free radicals can oxidize organic species, which may lead to degradation or crosslinking depending on the chemical nature of the species oxidized and other physical parameters such as temperature, pH, and free radical concentration. For example, free radicals can induce chain scission in hydrocarbons by abstracting hydrogen from a carbon present in a carbon chain, which produces a carbon radical that fragments—forming an olefin and a primary radical from the remainder of the carbon chain. The free radical chain reaction may then propagate until radicals are consumed by termination reactions.

Catalytic systems in accordance with the present disclosure may be used in various environments including the oil and gas industry, water purification applications, or for the remediation of various types of aqueous and non-aqueous wastes. In one or more embodiments, catalytic systems in accordance with the present disclosure may be used in recycling of drilling fluids, drilling slops, contaminated water sources, and other drilling and production wastes.

In some embodiments, catalytic systems may be used to remediate contaminated fluids by applying a catalytic system, as a component of a treatment fluid or through direct addition, to a fluid source containing organic or inorganic contaminants susceptible to degradation to non-toxic or less toxic byproducts. Contaminants may include hydrocarbons such as, but not limited to, gasoline, fuel oils, benzene, toluene, ethylbenzene, xylenes, naphthalene, pesticides, herbicides and other organic compounds; lubricants; chlorinated solvents, including polychlorinated ethylenes, trichlorinated ethylenes, vinyl chlorides, dichloro ethylenes, polychlorinated biphenyls (PCBs), pentachlorophenol (PCP), cyanides; metals; bacteria and microorganisms; and the like. When used to treat wellbore fluids, catalytic systems may disrupt emulsions or degrade oils, emulsifiers, polymers, and other organic constituents of oil- or water-based muds.

In one or more embodiments, catalytic systems may be mixed prior to addition or added sequentially to a contaminated water source such a storage tank or pit, or injected into a closed loop or semi-closed loop water circulation system. Admixture of the catalytic system with the contaminated water source may be initiated using mixers, blenders, pumps, or associated piping, and may be initiated at one or more locations when introduced into a flow loop so as to provide a sufficient residence time for obtaining the desired reduction in contamination.

In one or more embodiments, catalytic systems may be used in wellbore drilling operations as a treatment applied to wellbore fluids collected subsequent to injection into a wellbore. For example, following circulation into a wellbore, wellbore fluids may be returned to the surface and into a storage tank or pit. Returned fluids are often formulated with a number of rheological modifiers to have a specific density and viscosity and may contain a number of contaminants and solids entrained within the fluid. Thus, catalytic systems may be combined with returning wellbore fluids and/or added to stored wellbore fluids during remediation operations in some embodiments to reduce the viscosity of, or “break,” the wellbore fluid to aid in recycling wellbore fluids for reuse in additional wellbore fluid formulations or prior to disposal. In some embodiments, treatment of wellbore fluids with a catalytic system may reduce pumping energy required to transport the fluid and to enable the removal of contaminants and solids to reduce disposal costs.

Other possible applications include the use of catalytic systems to remove hydrocarbons and other contaminants from the surfaces of equipment, decking, and other work areas. In one or more embodiments, a catalytic system may be prepared and applied by spraying on to a contaminated surface, or by submerging contaminated materials or tools into a treatment solution containing a catalytic system.

In one or more embodiments, catalytic systems may be formulated as a wellbore fluid such as chemical breaker or displacement fluids for use in drilling, completions, and workover operations in subterranean wells. Wellbore fluids containing catalytic systems may address problems of efficient well clean-up and completion that may arise in wellbores, including completions conducted in open-hole horizontal or high angle wells. In some embodiments, breaker fluid formulations in accordance with the present disclosure may aid the removal of filter cake and reduce blockage, plugging, or damage to natural flow channels of the formation, or those of a completion assembly.

Breaker fluids of embodiments of this disclosure may be emplaced in the wellbore using conventional techniques known in the art, and may be used in drilling, completion, workover operations, etc. Additionally, one skilled in the art would recognize that such wellbore fluids may be prepared with a large variety of formulations. Specific formulations may depend on the stage in which the fluid is being used, for example, depending on the depth and/or the composition of the formation. The breaker fluids described above may be adapted to provide improved breaker fluids under conditions of high temperature and pressure, such as those encountered in deep wells, where high densities are required. Further, one skilled in the art would also appreciate that other additives known in the art may be added to the breaker fluids of the present disclosure without departing from the scope of the present disclosure.

The types of filter cakes that the present breaker fluids may break include those formed from oil-based or water-based drilling fluids. That is, the filter cake may be either an oil-based filter cake (such as an invert emulsion filter cake produced from a fluid in which oil is the external or continuous phase) or a water-based (such as an aqueous filter cake in which water or another aqueous fluid is the continuous phase). It is also within the scope of the present disclosure that filter cakes may also be produced with direct emulsions (oil-in-water), or other fluid types.

Catalytic systems may be formulated as a breaker fluid and circulated in the wellbore during or after the performance of at least one completion operation. In some embodiments, the breaker fluid may be pumped or spotted into the wellbore without circulation during or after the performance of at least one completion operation. In other embodiments, the breaker fluid may be circulated, spotted, or pumped either after a completion operation or after production of formation fluids has commenced to destroy the integrity of and clean up residual drilling fluids remaining inside casing or liners.

In some embodiments, methods may include incorporating one or more components of the catalytic system into a wellbore fluid during drilling, and then activating the dormant component during breaking applications by introducing the second component into the wellbore as a constituent of a breaker fluid. For example, a wellbore fluid may be formulated with a catalyst and incorporated into a filter cake during a drilling operation, while a peroxide source is introduced at a later time as a component of a breaker fluid. The opposite convention can also be envisioned in which a peroxide source is encapsulated or passivated and incorporated within a drilling fluid and degradation of the resulting filter cake is achieved by introducing the catalyst with a breaker fluid. Further, one component may be used during drilling and the second may be spotted at a target region in some embodiments. Combination of the components in situ may occur in situations where it is desired that the oxidation activity be concentrated at a particular region of the wellbore or where there is a concern that the peroxide source will be prematurely exhausted before reaching the region.

Depending on the arrangement of a catalytic system, control of the production of free radicals may be achieved in some embodiments by isolating the peroxide source and the catalyst and mixing the components when initiation of free radical production is desired. In some embodiments, one or more of the peroxide source and the catalyst may be inactivated or encapsulated to the production of radicals as needed to aid placement and effectiveness until release of the component from the encapsulant is triggered by the appropriate stimuli. Further, the production of free radicals may also be accompanied with an evolution of heat as the free radicals react with contaminants. Thus, in some embodiments, the catalytic system, or components thereof, may be added to a contaminated fluid or wellbore fluid in portions or in a metered stream such that the temperature remains in a predetermined range in accord with the requirements of the application.

Catalytic systems described herein may be formulated at various concentrations depending on the application and environmental conditions such as pH or temperatures. For example, low temperature applications may require an increased amount of catalyst or a peroxide source that degrades more readily.

### Peroxide Sources

Peroxide sources in accordance with embodiments disclosed herein include chemical reagents that dissociate via hemolytic cleavage of peroxides to produce free radical species such as hydroxyl radicals, alkoxy, or alkyl free radicals.

In one or more embodiments, peroxide sources may be selected from hydrogen peroxide, calcium peroxide, magnesium peroxide, alkali metal peroxides, dialkyl peroxides, peroxy acids such as peroxybenzoic acid and ring-substituted peroxybenzoic acids such as peroxy-naphthoic acid; aliphatic, substituted aliphatic, and arylalkyl monoperoxyacids such as peroxylauric acid, peroxystearic acid and N,N-phthaloylaminoperoxy caproic acid (PAP), and 6-octylamino-6-oxo-peroxyhexanoic acid. In some embodiments, peroxide sources may include diperoxyacids such as benzoyl peroxide, diperoxydodecanedioic acid (DPDA), 1,9-diperoxyazelaic acid, diperoxybrassilic acid, diperoxysebasic acid and diperoxyisophthalic acid, 2-decyldiperoxy butane-1,4-diotic acid, and 4,4′-sulphonylbisperoxybenzoic acid.

Peroxide sources may also be selected from delayed peroxide sources that release peroxide-forming species over a period of time or upon exposure to an appropriate stimulus such as contact with solvent, exposure to proper pH, or temperature. Delayed peroxide sources may include solid peroxide sources, percarbonates such as sodium percarbonate, perborates such as sodium perborate, persilicate salts, percarbamides (a urea/peroxide adduct), persulfate compounds such as potassium persulfate, sodium persulfate, ammonium persulfate, and the like. Other suitable radical initiators may include salts or derivatives of percarbonic acid (such as isopropyl percarbonate) and salts or derivatives of perphosphonic acid.

Peroxide sources in accordance with embodiments disclosed herein include active sources of peroxide such as hydrogen peroxide, or “passivated” peroxide sources that are encapsulated in a layer that insulates the peroxide source from a surrounding fluid or solid medium.

### Encapsulation Materials

In one or more embodiments, a peroxide source may be released from an encapsulating coating in response to an external stimulus or triggering event, which may include changes in temperature or pH; degradation of the encapsulant by enzymes, oxidants, or solvents; or physical disruption of the encapsulant, such as by grinding or crushing. It is also envisioned that encapsulants susceptible to triggered release may also be used in conjunction with passive diffusion encapsulants, and combined with any of the strategies disclosed above.

In particular embodiments, the encapsulant may be designed such that the encapsulant releases a reagent when exposed to shear forces such as those that occur during injection of a wellbore fluid downhole. For example, an encapsulated reagent may be injected into a wellbore and as the wellbore fluid containing the encapsulated reagent is exposed to shear forces that occur as the fluid exits an opening in a tubular, drill string, or drill bit, the shear forces may disrupt the encapsulating material and release the reagent into the surrounding fluid. Thus, the release and delivery of an encapsulated reagent may be obtained by tuning the shear pressure of the fluid injection in the wellbore.

In one or more embodiments, a component may be encapsulated in an organic coating prepared from cellulose acetate, cellulose acetate butyrate, ethyl cellulose, hydroxymethyl cellulose, hydroxyethyl cellulose, and the like. Other encapsulants include polystyrene, copolymers of polystyrene with other vinylic monomers, polymethylmethacrylate, copolymers of methylmethacrylate with other ethylenically-unsaturated monomers, acrylic resins, polyolefins, polyamides, polycarbonates, polystyrene, vinyl polymers such as vinyl acetate, vinyl alcohol, vinyl chloride, vinyl butyral, and copolymers, terpolymers, and quaternary polymers thereof. Examples of pH-sensitive polymers include poly(hydroxethyl)methacrylate-co-methacrylic acid) and a copolymer of N,N,dimethylaminoethyl methacrylate and divinyl benzene.

In yet another embodiment, peroxide sources may be encapsulated in a coating that releases the component or components in response to an external stimulus or triggering event, which may include temperature, pH, enzymatic degradation, oxidants, solvents, or physically disrupted, such as by grinding the encapsulated components. It is also envisioned that encapsulants susceptible to triggered release may also be used in conjunction with passive diffusion encapsulants, and combined with any of the strategies disclosed above.

The encapsulation material may be a heat-activated material that remains intact prior to exposure to elevated temperatures, such as those present in a downhole environment, and upon heating, slowly melt and release the molecules or ions contained within. In some embodiments, the coating may melt at a temperature greater than 125° F. (52° C.). Examples of such materials are vegetable fat, gelatin, and vegetable gums, and hydrogenated vegetable oil. Other coatings may include materials selected from lipid materials such as, but not limited to, mono-, di-, and tri-glycerides, waxes, and organic and esters derived from animals, vegetables, minerals, and modifications. Examples include glyceryl triestearates such as soybean oil, cottonseed oil, canola oil, carnuba wax, beeswax, bran wax, tallow, and palm kernel oil.

In a particular embodiment, the encapsulating material may include enteric polymers, which are defined for the purposes of the present disclosure, as polymers whose solubility characteristics are pH dependent. Here, this means that component release is promoted by a change from conditions of a first predetermined pH value to a second predetermined pH condition.

Enteric polymers are commonly used in the pharmaceutical industry for the controlled release of drugs and other pharmaceutical agents over time. The use of enteric polymers allows for the controlled release of a component under predetermined conditions of pH, or a combination of pH and temperature. For example, the Glascol® family of polymers are acrylic based polymers (available form Ciba Specialty Chemicals) are considered suitable enteric polymers for the present disclosure because the solubility depends upon the pH of the solution. In an illustrative embodiment of the present disclosure, an enteric polymer may be selected as an encapsulating material that is substantially insoluble at pH values greater than about 7.5 and that is more soluble under conditions of decreasing pH.

Encapsulating materials may also include enzymatically degradable polymers and polysaccharides such as galactomannan gums, glucans, guars, derivatized guars, starch, derivatized starch, hydroxyethyl cellulose, carboxymethyl cellulose, xanthan, cellulose, and cellulose derivatives. Enzymatically degradable polymers may include glycosidic linkages that are susceptible to degradation by natural polymer degrading enzymes, which may be selected from, for example, carbohydrases, amylases, pullulanases, and cellulases. In other embodiments, the enzyme may be selected from endo-amylase, exo-amylase, isoamylase, glucosidase, amylo-glucosidase, malto-hydrolase, maltosidase, isomalto-hydrolase or malto-hexaosidase. One skilled in the art would appreciate that selection of an enzyme may depend on various factors such as the type of polymeric additive used in the wellbore fluid being degraded, the temperature of the wellbore, and the pH of wellbore fluid

While a number of encapsulating compositions and release mechanisms have been discussed, many methods of encapsulating and releasing components described herein may alternatively be used without departing from the scope of the present disclosure.

In one or more embodiments, one or more peroxide sources may be added to a fluid or wellbore fluid in a concentration as a percent by weight of the fluid (wt %) that ranges from 2 wt % to 10 wt %. In other embodiments, the concentration may range from 4 wt % to 8 wt %.

### Catalysts

Catalysts that may be used in accordance with the embodiments disclosed herein include compounds and compositions that accelerate the decomposition of peroxide sources into their corresponding peroxide species.

In one or more embodiments, catalysts may be selected from metal salts such as iron or copper of various oxidation states including ferrous and ferric salts and copper salts including cupric and cuprous salts. When the catalyst is present as a salt any suitable counter anion may be used to complex the cationic component, including halides, borates, sulfates, nitrates, perchlorates, organic counter anions such as acetates, lactates, etc., and the like. In some embodiments, catalytic metals may be added initially as a metal with an oxidation state of 0, and oxidized in situ to create an active catalytic species.

In one or more embodiments, catalysts may be selected from heterogeneous catalysts that exist in a different phase from the species being oxidized, e.g., a catalyst may be present in an aqueous or solid phase separate from a non-aqueous contaminant. Suitable heterogeneous catalysts may be crystalline, amorphous, or a combination thereof, and may also include a relatively small amount of a modifying metal and/or a modifying metal oxide. Such modifying metal and/or modifying metal oxide may be selected from aluminum, gallium, iron, zinc, copper, titanium, and phosphorus; oxides thereof and combinations thereof. In some embodiments, one or more catalytic metals may be included together in a single catalyst, or in separate catalysts that are employed together. The amount of catalyst may range from trace amounts such as 10 parts per million (ppm) in some embodiments, up to 10% by weight (wt %), based on the total weight of the catalyst in other embodiments. In one or more embodiments, the catalyst may have a microporous crystalline aluminosilicate structure, and include one or more metals selected from above substituted into the structure.

In one or more embodiments, catalysts may be encapsulated using any of the above chemistries discussed with respect to the peroxide sources. In some embodiments, catalytic systems in accordance with the present disclosure include systems in which one or both of the peroxide source and catalyst components are encapsulated. It is also envisioned that, where both the peroxide source and the catalyst are encapsulated, that the chemistry used to encapsulate the components may be different for each component.

Reaction rates of catalytic systems in accordance with the present disclosure may be modified by adjusting the pH. In one or more embodiments, the pH of the fluid to which the catalyst system has been or will be added may be adjusted to a pH within the range of pH 1 to pH 9. In other embodiments the pH may be adjusted to within the range of pH 3 to pH 8.

Depending on the rate of radical produced by the catalytic system, temperature of the solution containing the catalytic system may also be adjusted to increase or decrease the rate of reaction. In one or more embodiment, temperature may be maintained at or below 20° C. In some embodiments, the temperature may be maintained within the range of 20° C. to 100° C. In yet other embodiments, temperature may be adjusted to 200° C. or lower.

In one or more embodiments, the ratio of catalyst to peroxide source may range from 1:2 to 1:20 in some embodiments, and from 1:5 to 1:15 in other embodiments.

### Chelating Agents

In other embodiments, a chelating agent may be added to bind and sequester the catalyst. For example, when added to a catalytic system in accordance with the present disclosure, a chelating agent may bind the catalyst, reducing the reaction rate between the peroxide source and the catalyst and decreasing the production of free radicals. In some embodiments, the chelating agent and the catalyst may be combined prior to addition to a solution containing the peroxide source, or added upon a determination that sufficient amount of free radicals has been generated for the given application. Binding of the chelating agent to the catalyst may be pH dependent in some embodiments, and pH may be used as a stimulus that triggers the release of the catalyst and thereby increases the production of free radicals. Conversely, where the rate of free radical production is determined to be sufficient or too rapid, the pH may be adjusted such that the affinity of the chelating agent for the catalyst is increased, and excess catalyst is sequestered by the chelating agent.

Chelating agents in accordance with the embodiments disclosed herein may sequester catalysts such as any of those described in the preceding sections through electrostatic interactions with one or more functional groups present on the chelating agent. Useful chelants may include organic ligands such as ethylenediamine, diaminopropane, diaminobutane, diethylenetriamine, triethylenetetraamine, tetraethylenepentamine, pentaethylenehexamine, tris(aminoethyl)amine, triaminopropane, diaminoaminoethylpropane, diaminomethylpropane, diaminodimethylbutane, bipyridine, dipyridylamine, phenanthroline, aminoethylpyridine, terpyridine, biguanide and pyridine aldazine.

In some embodiments, the chelating agent may be a polydentate chelator that forms multiple bonds with the complexed metal ion. Polydentate chelating agents may include, for example, ethylenediaminetetraacetic acid (EDTA), diethylenetriaminepentaacetic acid (DTPA), citric acid, nitrilotriacetic acid (NTA), ethylene glycol-bis(2-aminoethyl)-N,N,N′,N′-tetraacetic acid (EGTA) , 1,2-bis(o-aminophenoxy)ethane-N,N,N′,N′-tetraaceticacid (BAPTA), cyclohexanediaminetetraacetic acid (CDTA), triethylenetetraaminehexaacetic acid (TTHA), N-(2-Hydroxyethyl)ethylenediamine-N,N′,N′-triacetic acid (HEDTA), glutamic-N,N-diacetic acid (GLDA), ethylene-diamine tetra-methylene sulfonic acid (EDTMS), diethylene-triamine penta-methylene sulfonic acid (DETPMS), amino tri-methylene sulfonic acid (ATMS), ethylene-diamine tetra-methylene phosphonic acid (EDTMP), diethylene-triamine penta-methylene phosphonic acid (DETPMP), amino tri-methylene phosphonic acid (ATMP), salts thereof, and mixtures thereof. In one or more embodiments, the chelating agent may be D-SOLVER™ HD, which is commercially available from M-I L.L.C. (Houston, Tex.). However, this list is not intended to have any limitation on the chelating agents suitable for use in the embodiments disclosed herein. One of ordinary skill in the art would recognize that selection of the chelating agent used may depend on the particular catalyst selected. In particular, the selection of the chelating agent may be related to the specificity of the chelator to the particular cations, the logK value, the optimum pH for sequestering, and the commercial availability of the chelating agent, as well as conditions in which catalytic systems are being employed.

In one or more embodiments, the chelating agent may be added to a wellbore fluid or wellbore fluid at a percent by weight (wt %) of the final solution that may range from any lower limit selected from the group of 0.1 wt %, 0.5 wt %, 1 wt %, and 2 wt % to any upper limit selected from the group of 0.75 wt %, 1.0 wt %, 1.5%, 2 wt %, 3 wt %, and 5 wt %.

### Base Fluids

Base fluids useful for delivering the catalytic systems may include at least one of fresh water, sea water, brine, mixtures of water and water-soluble organic compounds, and mixtures thereof. In various embodiments, the aqueous fluid may be a brine, which may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium salts of chlorides, bromides, carbonates, iodides, chlorates, bromates, formates, nitrates, oxides, sulfates, silicates, phosphates and fluorides. Salts that may be incorporated in a brine include any one or more of those present in natural seawater or any other organic or inorganic dissolved salts.

Additionally, brines that may be used in the wellbore fluids disclosed herein may be natural or synthetic, with synthetic brines tending to be much simpler in constitution. In one embodiment, the density of the wellbore fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

Other suitable base fluids useful in methods described herein may be oil-in-water emulsions or water-in-oil emulsions in one or more embodiments. Suitable oil-based or oleaginous fluids that may be used to formulate emulsions may include a natural or synthetic oil and in some embodiments, in some embodiments the oleaginous fluid may be selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids, mixtures thereof and similar compounds known to one of skill in the art; and mixtures thereof.

Breaker fluids as disclosed herein may also be used in a cased hole to remove any drilling fluid left in the hole during any drilling and/or displacement processes. Well casing may consist of a series of metal tubes installed in the freshly drilled hole. Casing serves to strengthen the sides of the well hole, ensure that no oil or natural gas seeps out of the well hole as it is brought to the surface, and to keep other fluids or gases from seeping into the formation through the well. Thus, during displacement operations, typically, when switching from drilling with an oil-based mud to a water-based mud (or vice-versa), the fluid in the wellbore is displaced with a different fluid. For example, an oil-based mud may be displaced by another oil-based displacement to clean the wellbore. The oil-based displacement fluid may be followed with a water-based displacement fluid prior to beginning drilling or production. Conversely, when drilling with a water-based mud, prior to production, the water-based mud may be displacement water-based displacement, followed with an oil-based displacement fluid. Further, one skilled in the art would appreciate that additional displacement fluids or pills, such as viscous pills, may be used in such displacement or cleaning operations as well, as known in the art.

Another embodiment of the present disclosure involves a method of cleaning up a well bore drilled with an oil based drilling fluid. In one such illustrative embodiment, the method involves circulating a breaker fluid disclosed herein in a wellbore, and then shutting in the well for a predetermined amount of time, typically while production tubing and flow line are run, and/or the well is lined-up to the designated production facility, to allow penetration and fragmentation of the filter cake to take place. Subsequently the designated well is brought on-line whereby the initial clean-up of the well is initiated and fluids from the flowline, production tubing and finally the open hole flow to the surface thus transporting the now spent breaker fluid to the surface.

The fluids disclosed herein may also be used in a wellbore including a barefoot completion or a screened completion, for example. After a hole is drilled to a desired diameter (or under-reamed to widen the diameter of the hole), the drilling string may be removed and replaced with a completion assembly which includes in some cases a desired sand control screen. Alternatively, an expandable tubular sand screen may be run into the open hole and expanded in place or a gravel pack may be pumped in the open hole. Breaker fluids may be placed in the well, and the well is then shut in to allow penetration and fragmentation of the filter cake to take place. Upon fragmentation of the filter cake, the fluids can be easily produced from the well bore upon initiation of production and thus the residual filtercake, in part or in whole, is produced out of the well bore. Alternatively, a wash fluid (different from the breaker fluid) may be circulated through the wellbore prior to commencing production.

However, the breaker fluids disclosed herein may also be used in various embodiments as a displacement fluid and/or a wash fluid. As used herein, a displacement fluid is typically used to physically push another fluid out of the wellbore, and a wash fluid typically contains a surfactant and may be used to physically and chemically remove drilling fluid reside from downhole tubulars. When also used as a displacement fluid, the breaker fluids of the present disclosure may act effectively push or displace the drilling fluid. When also used as a wash fluid, the breaker fluids may assist in physically and/or chemically removing the filter cake, in part or in whole, once the filter cake has been disaggregated by the breaker system.

In one or more embodiments, the present fluids may be incorporated into gravel packing carrier fluids. Breaker fluids are typically used in cleaning the filtercake from a wellbore that has been drilled with either a water-based drilling mud or an invert emulsion based drilling mud. Breaker fluid are typically circulated into the wellbore, contacting the filter cake and any residual mud present downhole, may be allowed to remain in the downhole environment until such time as the well is brought into production. The breaker fluids may also be circulated in a wellbore that is to be used as an injection well to serve the same purpose (i.e. remove the residual mud and filter cake) prior to the well being used for injection of materials (such as water surfactants, carbon dioxide, natural gas, etc . . . ) into the subterranean formation. Thus, the fluids disclosed herein may be designed to form two phases, an oil phase and a water phase, following dissolution of the filtercake which can easily be produced from the wellbore upon initiation of production. Regardless of the fluid used to conduct the drilling (or under-reaming) operation, the fluids disclosed herein may effectively degrade the filtercake and substantially remove the residual drilling fluid from the wellbore upon initiation of production.

Further, it is also within the scope of the present disclosure that the present breaker components may be incorporated into a carrier fluid for gravel packing. Specific techniques and conditions for pumping a gravel pack composition into a well are known to persons skilled in this field. The conditions which can be used for gravel-packing in the present invention include pressures that are above fracturing pressure, particularly in conjunction with the Alternate Path Technique, known for instance from U.S. Pat. No. 4,945,991, and according to which perforated shunts are used to provide additional pathways for the gravel pack slurry. Furthermore, certain oil based gravel pack compositions of the present invention with relatively low volume internal phases (e.g., discontinuous phases) can be used with alpha- and beta-wave packing mechanisms similar to water packing.

Further, a wellbore contains at least one aperture, which provides a fluid flow path between the wellbore and an adjacent subterranean formation. In an open hole completed well, the wellbore's open end, that is abutted to the open hole, may be the at least one aperture. Alternatively, the aperture can comprise one or more perforations in the well casing. At least a part of the formation adjacent to the aperture has a filter cake coated on it, formed by drilling the wellbore with either a water- or oil-based wellbore fluid that deposits on the formation during drilling operations and comprises residues of the drilling fluid. The filter cake may also comprise drill solids, bridging/weighting agents, surfactants, fluid loss control agents, and viscosifying agents, etc. that are residues left by the drilling fluid.

### EXAMPLES

The following examples are provided to demonstrate various approaches to preparing and using catalytic systems in accordance with the present disclosure

An embodiment of catalytic system was formulated as a breaker fluid and was combined with a sample of drilling fluid containing a polymeric viscosifier to assay the efficiency of the breaker fluid in reducing viscosity. The drilling fluid sample was prepared from 105 grams of SAFETHERM™, an aqueous-based wellbore fluid containing a polymeric viscosifiying system, which is commercially available from M-I SWACO (Houston, Tex.).

The wellbore fluid was combined with a catalytic system containing 15 mL of a 1:10 ratio of ferric sulfate catalyst to 50% hydrogen peroxide. The catalytic system was prepared by adding 1.5 g ferric sulfate catalyst to 15 ml water, followed by addition of 15 ml 50% hydrogen peroxide in portions. The pH was determined to be pH 3.5 prior to addition to the wellbore fluid. Following addition, there was an evolution of heat and a release of gas, and after a period of 30 minutes the viscosity of the sample was reduced to approximately that of water. The experiment was repeated to verify reproducibility. In some samples a small amount of precipitate formed that appeared to be a xanthan gum or xanthan gum derivative as determined by FTIR. Comparative samples were prepared using substantially the same conditions noted above, but excluding the ferric sulfate catalyst. To achieve the a similar viscosity break, a sample containing only hydrogen peroxide was heated overnight, while another was allowed to react over six weeks at room temperature.

Portions of the broken fluid were obtained from the sample treated with the catalytic system and the sample treated with hydrogen peroxide overnight and were analyzed by gas chromatography/mass spectroscopy (GC/MS). Overall results indicated that the sample of aqueous wellbore fluid treated with the catalytic system contained no detectable amount of residual water-miscible hydrocarbon solvent. In contrast, the comparative sample treated with hydrogen peroxide alone continued to register the presence of a measureable quantity of the water-miscible hydrocarbon solvent.

Although the preceding has been described herein with reference to particular means, materials, and embodiments, it is not intended to be limited to the particulars herein; rather, it extends to all functionally equivalent structures, methods, and uses such as are within the scope of the appended claims.

What is claimed:

1. A method, comprising:
circulating a breaker fluid into a wellbore, the breaker fluid comprising:
a base fluid;
a peroxide source; and
a catalyst.

2. The method of claim 1, wherein the peroxide source is one or more delayed peroxide sources selected from a group consisting of percarbonates and percarbamides.

3. The method of claim 1, wherein one or more of the peroxide source and catalyst are encapsulated.

4. The method of claim 1, wherein the pH of the wellbore fluid is adjusted to a pH in the range of pH 3 to pH 8.

5. The method of claim 1, wherein the catalyst is one or more selected from a group consisting of ferric salts, ferrous salts, cupric salts, and cuprous salts.

6. The method of claim 1, wherein the breaker fluid further comprises a chelating agent.

7. The method of claim 1, wherein the ratio of the catalyst to the peroxide source is within the range of 1:5 to 1:15.

8. A method, comprising:
drilling a wellbore with a drilling fluid comprising a catalyst; and
circulating a breaker fluid into a wellbore, the breaker fluid comprising:
a base fluid; and
a peroxide source.

9. The method of claim 8, wherein the pH of the wellbore fluid is adjusted to a pH in the range of pH 3 to pH 8.

10. The method of claim 8, wherein the catalyst is a solid metal, and wherein the metal is oxidized in situ to create an active catalytic species.

11. The method of claim 8, wherein one or more of the peroxide source and catalyst are encapsulated.

12. The method of claim 8, wherein the catalyst is one or more selected from a group consisting of ferric salts, ferrous salts, cupric salts, and cuprous salts.

13. The method of claim 8, wherein the catalyst further comprises a chelating agent.

14. The method of claim 8, wherein the ratio of the catalyst to the peroxide source is within the range of 1:5 to 1:15.

15. A method, comprising:
treating a contaminated fluid with a treatment fluid comprising:
a base fluid;
a peroxide source; and
a catalyst.

16. The method of claim 15, wherein the peroxide source is one or more delayed peroxide sources selected from a group consisting of percarbonates and percarbamides.

17. The method of claim 15, wherein one or more of the peroxide source and catalyst are encapsulated.

18. The method of claim 15, wherein the pH of the fluid is adjusted to a pH in the range of pH 3 to pH 8.

19. The method of claim 15, wherein the catalyst is a solid metal, and wherein the metal is oxidized in situ to create an active catalytic species.

20. The method of claim 15, wherein the catalyst further comprises a chelating agent.
